(19) United States
(12) Patent Application Publication
(10) Pub. No.: US 2008/0288588 A1
(43) Pub. Date: Nov. 20, 2008

(54) Method and system for searching using image based tagging

(75) Inventors: Kenneth Andam, Highland, UT (US); James M. Jensen, American Fork, UT (US); Jared Weinman, American Fork, UT (US)

Correspondence Address: THORPE NORTH & WESTERN, LLP., P.O. Box 1219, SANDY, UT, 84091-1219, US

(73) Assignee: Worldvuer, Inc., American Fork, UT (US)

(21) Appl. No.: 11/982,728

(22) Filed: Nov. 1, 2007

Related U.S. Application Data
(60) Provisional application No. 60/863,942, filed on Nov. 1, 2006.

(51) Int. Cl. G06F 7/06; G06F 17/30; G06F 15/16

(52) U.S. Cl. 709/204; 707/3; 707/E17.014; 707/E17.019

(57) ABSTRACT

A system and method are provided for searching networked electronic media. The method includes the operation of mapping a user selected keyword to a category identifier for search result generation in a search engine. A search result can be produced that contains alisting of URLs for the category identifier. Then the search result can be dynamically populated with images through identity mapping of the image to a URL. The search can determine the display images to a URL based on a user's profile, like age, and the URL's popularity with other users sharing a similar user profile. The URLs and an associated image for the search can be obtained through a community of users.

### PRIORITY CLAIM

Priority of U.S. Provisional Patent Application Ser. No. 60/863,942 filed on Nov. 1, 2006 is claimed.

### FIELD OF THE INVENTION

The present invention relates generally to electronic searching. More particularly, the present invention relates to creating and displaying URLs as logo images during electronic searches.

### BACKGROUND

Electronic search engines can be used to search many types of databases. One popular use of search engines enables users to search for content on the Internet. Companies like Yahoo.com, Google.com, Ask.com, Alta Vista and others allow users to type in keywords to form a text based query. Then the user receives back search results in the form of a listing. These content based search results are generally text based in nature and the users can read through the search results to find what they are looking for.

Reading through the search results can take a significant amount of time. Sometimes the search results that the user is looking for may be located a long way down the list or on the fifth or sixth pages of the search result. Users may have to read through a large number of results to find the specific information the user is looking for. This type of searching can be cumbersome and time consuming.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an illustration exemplary of a registration page in accordance with an embodiment of the present invention;

FIG. 2 is an illustration exemplary of a user administration page in accordance with an embodiment of the present invention; and

FIG. 3 is an illustration exemplary of a limited user homepage graphical user interface (GUI), which can be used by children and older adults in accordance with an embodiment of the present invention; and

FIG. 4 is an illustration exemplary of an agent login page in accordance with an embodiment of the present invention; and

FIG. 5 is an illustration exemplary of an agent homepage in accordance with an embodiment of the present invention; and

FIG. 6 is a flow chart exemplary of the method for displaying image link categories using a user profile in accordance with an embodiment of the present invention.

FIG. 7 is a flow chart exemplary of the a method for collecting URLs in a database for searching networked electronic media using a community of users in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A system and method are provided for searching websites using image based tagging of URLs (Universal Resource Locators) or electronic media. The URLs or electronic media may be HTML pages, websites, image databases, and other types of linkable objects and electronic media on a network.

One method includes the operation of enabling a user to enter search terms into a search query entry box. Then the search terms may be mapped using one or more user entered keywords to unique category and sub-category identifiers for search result generation in a search engine. The category will maintain a listing of web addresses, image links, websites or other URLs. The web addresses may be a base domain name or a deeper link into a website.

The search result may be dynamically populated with images through identity mapping of the image or logo to the website address or deeper link within the website. For example, the company logo may be associated with the company's domain names web address. If the web address is EBay, then EBay's corporate logo can be associated with the web address. In the case where a product is associated with the web link or web address, the product logo can be mapped or tied to the web address. For example, if a Kellogg's Corn Flakes link is being shown, the logo or image can represent Kellogg's cornflakes as opposed to the company's logo.

The search results can be sorted using a most searched criteria to determine the most relevant pages for any plurality of keyword tags associated with any plurality of websites. The most relevant pages can also be ranked based on the frequency of any search request by any number of users searching for information on the network.

A valuable side benefit of this method is that a user can access a website without typing in a URL in a web or internet browser. Moreover, the user does not need to use a significant amount of text content or links, as in current browsers. The user can look at the pictures associated with the links and this increases the speed at which the user can review the search results.

In one embodiment of the system and method, the search engine does not use any web crawler software or programs to populate the database of websites and images. This is because hand picking of web sites and content categories provides high quality results. The website stored in the database can be hand picked by agents. Users can invite their friends to participate in the database population or use of the overall system by e-mail.

In another embodiment of the invention, the database may be generated by automated methods, but the automated web results can be groomed and modified by individuals. This means that a community of people are editing and modifying the search results.

The present system allows users to generate a search using only pointing and clicking. A user can navigate existing topical directories or build a query graphically to find relevant subject matter. This interface design can help those who are “web and search impaired” because they do not need to type keywords or read through cryptic search results. This is because people are familiar with company and product branding. For example, 2 to 4 year olds who used the described interface to access the internet were able to recognize many of the companies and brand names that were returned in a search list.

Company branding can be displayed with the respective website in the user interface. Branding is pushed on the typical consumer or child so many times a day that they know it without even reading the name. This is an effective way to display search content for any topic on the Internet.

The image buttons and/or website images can be dynamically sorted into favorites. The user interface can be programmed to sort favorites in each category that the user goes to. For instance, when a user goes to the music category or search and they add a favorite, that site is only added to that category for that user. If that user then chooses to search shopping and they add a favorite, that site is stored in shopping favorites. The software can also sort the users favorites by the number of times a particular website is visited, so the user's most used web sites are presented right up front for the user.

The users can create different user names for a login account. When a user signs up with search software, the system allows the user to create different user names with their own logins and features. All of the user names and logins are contained within the same account. This allows the database to save all favorites and features for each user on that account.

An administrator for a login account can choose homepage interfaces for each user. For example the administrator can choose a child's homepage for a 4-year-old. Then choose an X-Games homepage for their 17-year-old.

The search engine database may only store sites that are approved by agents. The user or consumer can add sites to their favorites and those sites are then sent to the database where they wait in a queue for the system agents (actual people) to then review and place the website in the right category and sub-category for the keywords. In addition, the system searches only the database of approved sites due to the approval system. An account administrator can create time or content schedules for each user. Inside the Administrator tools, the admin can create different schedules for each user.

A method and apparatus are provided for creating a user defined list of favorite websites that are graphically represented with images that are tagged to defined domains that represent the websites. The searching can be performed by keyword, category, and sub-category. A search result can be dynamically populated with company branding, product logos, or other images that are relevant for the web URL or web address.

The favorite websites or links for a user can be applied or removed for a particular user. Users can also be grouped with other users. A defined homepage of websites or links can be assigned to a particular user. This allows the user to view the homepage every time they enter the system, if the user sets that option. A weekly time schedule can be provided for particular users. This may be a time limitation regarding when the system can be used. The software can display groups and users with different types of logins within a web browser. The software system can display a sorted list of URLs based on popularity, category, sub-category and sponsored URL links. The user can also save favorite URL links by company branding, image, category and sub-category. In one embodiment, the users can browse URL links by company branding.

Users can search the imaged websites or URLs by keyword, category and subcategory. Once a search result has been returned, the search results can be dynamically populated with company branding or images related to the links.

The list of images related to the websites, URLs, or links can be a sorted list based on popularity, category, sub-category, and sponsored links. Favorite links can be saved by company branding, category, and subcategory. As mentioned before, the URL links can be browsed by company brands alone or company brands alone based on a topic. The company brands may be in alphabetic order or some other sponsored advertising order.

Administrators or agents can have an interface for viewing URLs, companies and agents that have been added to the database. The software can include logging for an agent account to record the number of websites or links that have been processed. An interface can be provided for collecting information from a user for an agent account. The agent's administrative window can display the agent's information. The window may provide an engine or process to enable agents to search and add URLs to the database. The appropriate interface can be provided to allow agents to categorize, sub-categorize, describe, add keywords, and upload an image for all URL links.

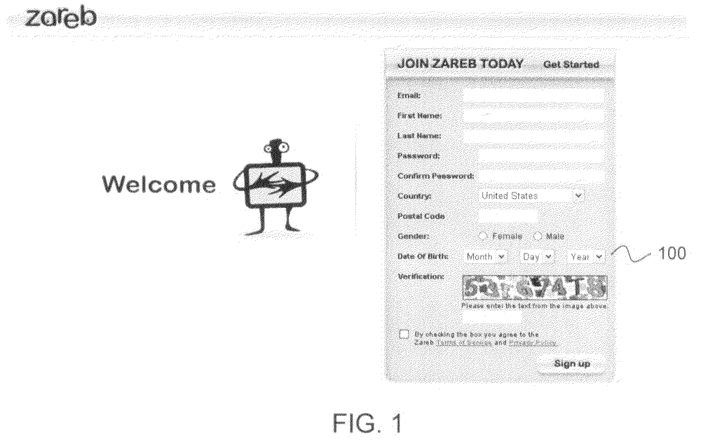

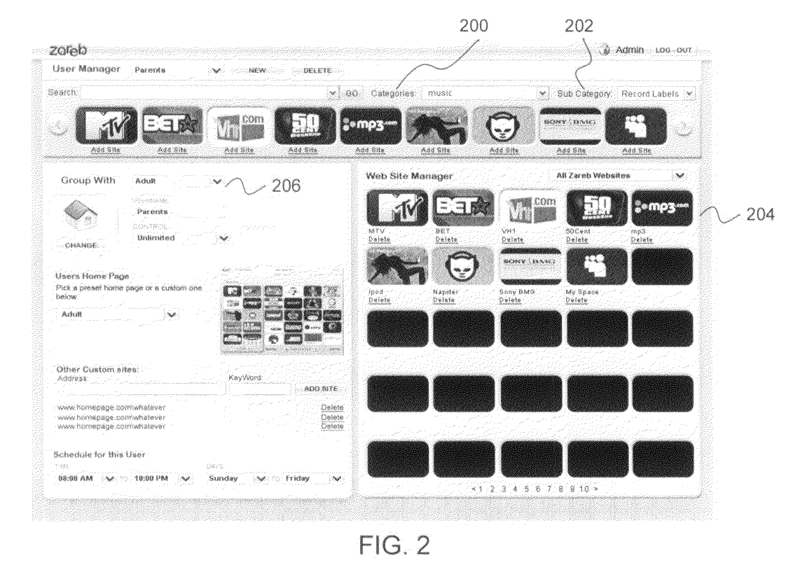

In one embodiment, a user can display a search result with website logos based on websites that other users with a similar user profile use. A user can create a user profile when they register for the service specifying predetermined fields such as age 100, gender, interests, employment, etc, as shown in FIG. 1. Users with similar profiles can be grouped together. In one embodiment the predetermined field was age. Based on age, the user age may be placed in one of three groups 206: Child, teenager, or adult, as shown in FIG. 2. Based on other users in the same group the search can display websites relevant to a child or other group. If the search category 200 was music, the search results would vary based on the group that was used. The music websites displayed for adults can be different from the music websites displayed for teenagers. The music websites for children can be different from music websites for both teenagers and adults. The categories a website is linked to can be further categorized into subcategories 202, like record labels, as shown in FIG. 2. The websites used by a user of a specific age in an age group are only linked to categories associated with that age group. These categories can be searched by other users with a similar profile, like age, so the most relevant websites used by peers will be displayed.

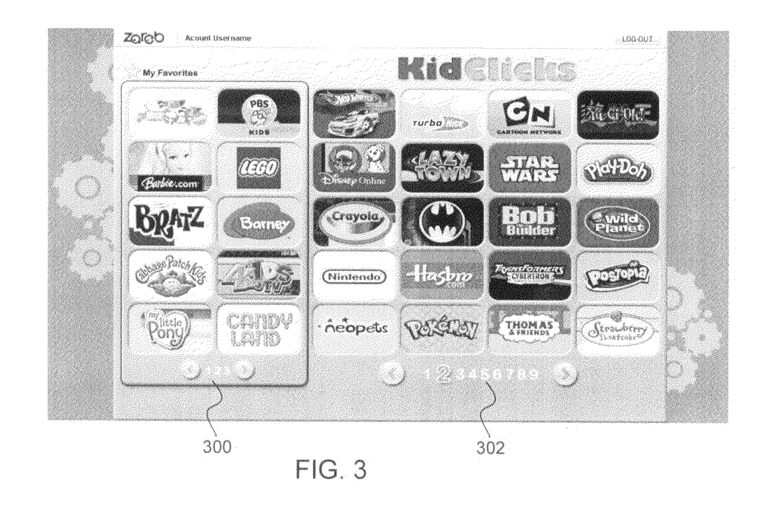

In another embodiment, the method for collecting websites for use by an individual user in a personal database or for use by all users in a common database can be done by a community of users. A user can find a website or URL, like www.lego.com, that they want to bookmark for future use. They can also determine the logo image, the LEGO™ brick, and key phrase (toys) the users want to use for future searches. The URL and logo image form an image link and the image link is saved in a personal section of the database accessible to individual users. When a key phrase category 200 is selected, the image links associated with the key phrase category displays the user's personal favorite logo images 300 of that category, as shown FIG. 3. The key phrase can be a key word or a series of key words. When a user only adds image links to categories viewable by that individual user, the link is stored in a personal key phrase category. When the image link is viewable by all users, the link is stored in a common key phrase category.

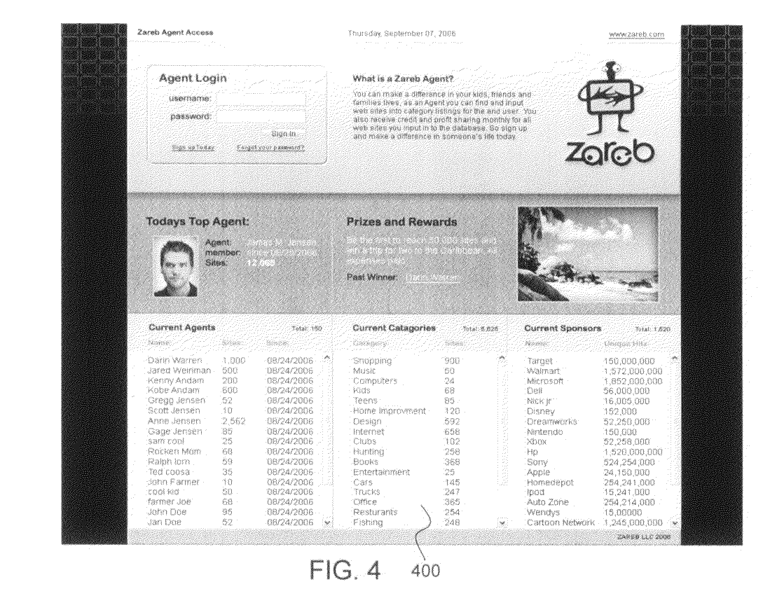

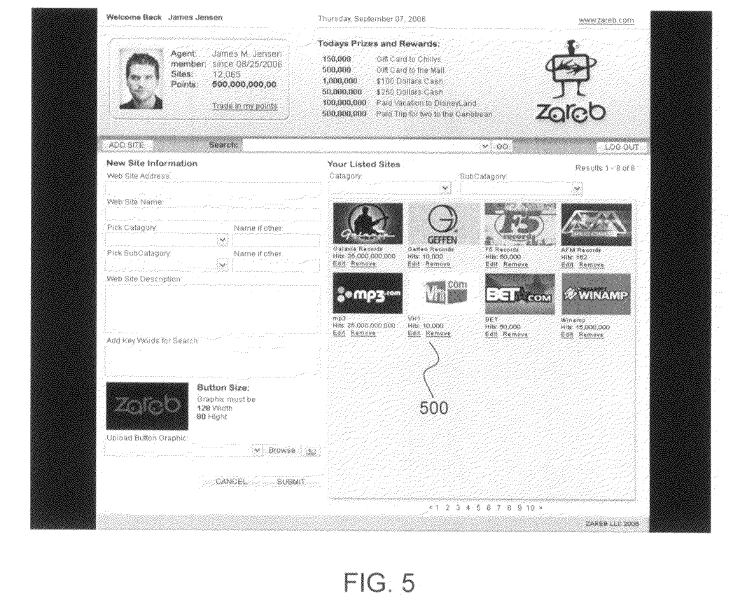

Once an image link is stored in a personal key phrase category, the link with the associated category is placed in a queue to be added to the common key phrase category. Image links associated with a key phrase category are approved or disapproved by a decision maker, usually a human being, before being added to the common key phrase category. The human decision makers that approve and add image links to the common key phrase categories are agents, as shown in FIG. 4. The agent can edit or remove 500 the logo image or the category associated with the URL, as shown in FIG. 5. Once an agent approves the image link to a category, the image link is stored in the common key phrase category and available to all users. Both personal key phrase category logo images 300 and common key phrase category logo images 302 can be displayed when a key phrase is used on a search, as shown in FIG. 3.

The embodiment described immediately above, can also include a rejection flag, which attaches a flag to image link and key phrase category when the agent disapproves an image like being stored in a category. This eliminates unnecessary work for agents disapproving the same image link in a category repeatedly.

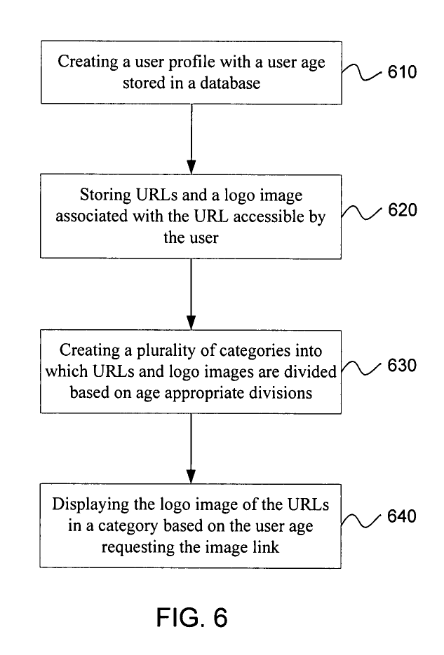

In another embodiment, a method for displaying image link categories using a user profile is shown in FIG. 6. A user profile can be created with a user age stored in a database 610. URLs and a logo image associated with the URL can be stored and accessible by the user 620. A plurality of categories into which URLs and logo images can be created and divided based on age appropriate divisions 630. The logo image of the URLs in a category based on the user age requesting the image link can be displayed 640.

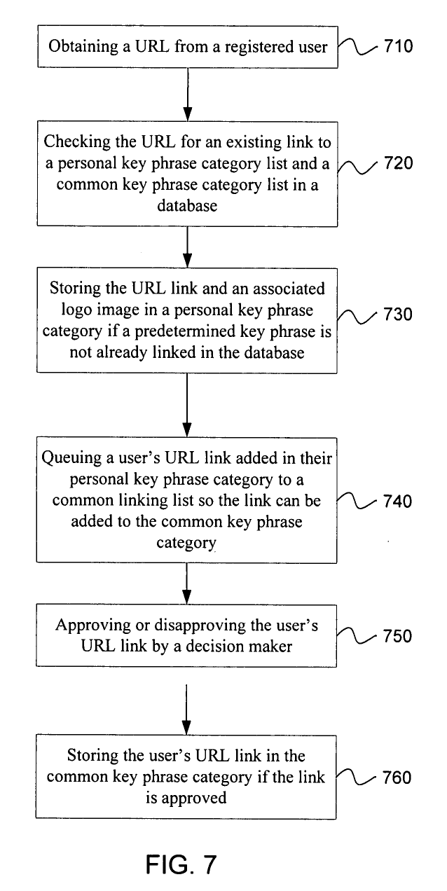

In another embodiment, a method for collecting URLs in a database for searching networked electronic media using a community of users is shown in FIG. 7. A URL can be obtained from a registered user 710. The URL for an existing link can be checked in a personal key phrase category list and a common key phrase category list in a database 720. The URL link and an associated logo image in a personal key phrase category can be stored if a predetermined key phrase is not already linked in the database 730. A user's URL link added in their personal key phrase category can be queued to a common linking list so the link can be added to the common key phrase category 740. The user's URL link by a decision maker can be approved or disapproved 750. The user's URL link in the common key phrase category can be stored if the link is approved 760.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for displaying image link categories using a user profile, comprising the steps of:
creating a user profile with predetermined fields stored in a database;
storing URLs and an associated image together as image links accessible by the user;
creating a plurality of categories into which image links are divided based on predetermined fields;
displaying the image of the image link in a category based on the predetermined field in the user profile of a user requesting the image link.

2. A method as in claim 1, wherein the predetermined field is age, gender, interests, or employment.

3. A method as in claim 1, further comprising the step of:
counting the number of image links accessed by all users with the same predetermined field in a category and storing the number in the database to determine popularity;
wherein the displayed logo images are arranged by popularity.

4. A method as in claim 1, wherein the images are an image representing a webpage.

5. A method as in claim 1, wherein the images are a commercial logo representing a website.

6. A method as in claim 1, wherein the creating of categories further comprises creating sub-categories.

7. A method for displaying image link categories using a user profile, comprising the steps of:
creating a user profile with a user age stored in a database;
storing URLs and a logo image associated with the URL accessible by the user;
creating a plurality of categories into which URLs and logo images are divided based on age appropriate divisions;
displaying the logo image of the URLs in a category based on the user age requesting the image link.

8. A method as in claim 7, further comprising the step of:
counting the number of URLs accessed by all users in a category and storing the number in the database to determine popularity;
wherein the displayed logo images are arranged by popular accesses.

9. A method as in claim 7, wherein the creating of categories further comprises creating sub-categories.

10. A method as in claim 7, wherein an image link includes a commercial logo.

11. A method as in claim 7, wherein a URL is a web address.

12. A method for collecting URLs in a database for searching networked electronic media using a community of users, comprising the steps of:
obtaining a URL from a registered user;
checking the URL for an existing link to a personal key phrase category list and a common key phrase category list in a database;
storing the URL link and an associated logo image in a personal key phrase category if a predetermined key phrase is not already linked in the database;
queuing a user's URL link added in their personal key phrase category to a common linking list so the link can be added to the common key phrase category;
approving or disapproving the user's URL link by a decision maker;
storing the user's URL link in the common key phrase category if the link is approved.

13. A method as in claim 12, further comprising the steps of:
verifying the user's URL link with a rejection flag linked to the URL and the common key phrase after the queuing step and rejecting the user's URL link if the rejection flag is set; and
setting the rejection flag linked to the URL and the common key phrase if the URL gets disapproved by the decision maker;

14. A method as in claim 12, wherein the URL is an image link of a URL combined with a logo image.

15. A method as in claim 12, wherein the categories further comprises sub-categories.

16. A method as in claim 12, wherein the decision maker is human.

17. A method as in claim 12, wherein at least one URL is a website address.

18. A system for displaying categories using a user profile, comprising the steps of:
a input device for a user to enter the user profile and a category key phrase;
a processing unit connected to the input device to prompt the user for input, receive user responses, retrieve responses from the database, and perform other processing functions;
a database assessible to the processing unit to store user responses, URLs, logo images, and key phrases category links;
a display unit connected to the processing unit to display logo images of the URLs in a category.

19. A system as in claim 18, further comprising:
a communication module connected to the client and a network of other computers so the client can send and receive information from other computers.
